(19) United States
(12) Patent Application Publication
(10) Pub. No.: US 2026/0212791 A1
(43) Pub. Date: Jul. 23, 2026

(54) Circular Bent Display

(71) Applicant: Google LLC, Mountain View, CA (US)

(72) Inventor: Choongho Lee, San Diego, CA (US)

(21) Appl. No.: 19/140,800

(22) PCT Filed: Dec. 21, 2022
(86) PCT No.: PCT/US2022/053627

§ 371 Date: Jun. 18, 2025

(51) Int. Cl. G09G 3/00; G09G 3/3208

(52) U.S. Cl. CPC G09G 3/03; G09G 3/3208; G09G 2354/00

(57) ABSTRACT

A display assembly for an electronic device is provided. The display assembly includes a display cover. The display cover defines an internal volume having a central portion and a peripheral portion. The display assembly further includes a display. The display includes a first display area having a first plurality of pixels. The first display area is disposed within the central portion of the internal volume. The display further includes a second display area having a second plurality of pixels. The second display area is disposed at least partially within the peripheral portion of the internal volume and extends around a periphery of the first display area. The display even further includes an arcuate connection portion disposed on the second display area. The arcuate connection portion defines a periphery of the second display area.

### FIELD

The present disclosure relates generally to displays for wearable computing devices. More particularly, the present disclosure relates to a display assembly for wearable computing devices having a circular bent display.

### BACKGROUND

Wearable computing devices (e.g., wrist watches) can include a display to display content (e.g., time, date, etc.) to a user. Wearable computing devices can gather data regarding activities performed by the user, or regarding the user's physiological state. Such data may include data representative of the ambient environment around the user or the user's interaction with the environment. For example, the data can include motion data regarding the user's movements and/or physiological data obtained by measuring various physiological characteristics of the user, such as heart rate, perspiration levels, and the like.

### SUMMARY

Aspects and advantages of embodiments of the present disclosure will be set forth in part in the following description, or can be learned from the description, or can be learned through practice of the embodiments.

In one aspect, a display assembly is provided. The display assembly includes a display cover defining an internal volume and a display. The internal volume includes a central portion and a peripheral portion. The display includes a first display area having a first plurality of pixels. The first display area can be disposed within the central portion of the internal volume. The display includes a second display area having a second plurality of pixels. The second display area can be disposed at least partially within the peripheral portion of the internal volume. The second display area extends around a periphery of the first display area. The display includes an arcuate connection portion. The arcuate connection portion can be disposed on the second display area. The arcuate connection portion can define a periphery of the second display area.

In some embodiments, the second display area includes a top portion, a curved portion, and a bottom portion. The top portion extends from the periphery of the first display area to a first end of the arcuate connection portion. The curved portion is defined by the arcuate connection portion and extends between the first end of the arcuate connection portion and a second end of the arcuate connection portion. The bottom portion extends from the second end of the arcuate connection portion toward the central portion of the internal volume. In some embodiments, the top portion of the second display area is flat.

In some embodiments, the arcuate connection portion is configured to bend the second display area within the peripheral portion of the internal volume. In some embodiments, the arcuate connection portion is configured to bend the second display area in a circular shape.

In some embodiments, the arcuate connection portion includes a substrate formed from a flexible material. In some embodiments, the arcuate connection portion includes a plastic substrate.

In some embodiments, the display assembly includes a first plurality of touch sensors. Each touch sensor of the first plurality of touch sensors is operable to detect a touch input provided at a central portion of the display cover. The display assemble includes a second plurality of touch sensors. Each touch sensor of the second plurality of touch sensors is operable to detect a touch input provided at a peripheral portion of the display cover.

In some embodiments, the display assembly includes a first plurality of conductors. Each conductor of the first plurality of conductors is electrically coupled to a corresponding pixel of the first plurality of pixels. The display assembly includes a second plurality of conductors. Each conductor of the second plurality of conductors is electrically coupled to a corresponding pixel of the second plurality of pixels. The display assembly includes a display driver circuit. The display driver circuit includes a first memory buffer communicatively coupled to each pixel of the first plurality of pixels via a corresponding conductor of the first plurality of conductors. The display driver circuit includes a second memory buffer communicatively coupled to each pixel of the second plurality of pixels via a corresponding conductor of the second plurality of conductors.

In some embodiments, a total number of pixels included in the first plurality of pixels is different than a total number of pixels included in the second plurality of pixels.

In some embodiments, the display cover is formed from a transparent material.

In some embodiments, the first display area and the second display area include an organic light-emitting diode (OLED) display.

In another aspect, a wearable computing device is provided. The wearable computing device includes a housing. The wearable computing device includes a display cover positioned on the housing. The display cover can define an internal volume. The internal volume includes a central portion and a peripheral portion. The wearable computing device includes a display positioned within the internal volume. The display includes a first display area having a first plurality of pixels. The first display area can be disposed within the central portion of the internal volume. The display includes a second display area having a second plurality of pixels. The second display area can be disposed at least partially within the peripheral portion of the internal volume. The second display area extends around a periphery of the first display area. The display includes an arcuate connection portion. The arcuate connection portion can be disposed on the second display area. The arcuate connection portion can define a periphery of the second display area.

In some embodiments, the wearable computing device includes a first plurality of conductors. Each conductor of the first plurality of conductors is electrically coupled to a corresponding pixel of the first plurality of pixels. The wearable computing device includes a second plurality of conductors. Each conductor of the second plurality of conductors is electrically coupled to a corresponding pixel of the second plurality of pixels. The wearable computing device includes a display driver circuit. The display driver circuit includes a first memory buffer communicatively coupled to each pixel of the first plurality of pixels via a corresponding conductor of the first plurality of conductors. The display driver circuit includes a second memory buffer communicatively coupled to each pixel of the second plurality of pixels via a corresponding conductor of the second plurality of conductors.

In some embodiments, the arcuate connection portion is configured to bend the second display area within the peripheral portion of the internal volume. In some embodiments, the housing of the wearable computing device is circular, and the arcuate connection portion is configured to bend the second display area in a circular shape.

In some embodiments, the arcuate connection portion includes a substrate formed from a flexible material. In some embodiments, the arcuate connection portion includes a plastic substrate.

In some embodiments, the display cover is formed from a transparent material.

In some embodiments, the first display area and the second display area include an organic light-emitting diode (OLED) display.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates an embodiment of a wearable computing device according to example embodiments of the present disclosure;

FIG. 2 illustrates a cross-sectional view of an example wearable computing device according to example embodiments of the present disclosure;

FIG. 3 illustrates an exploded view of a wearable computing device according to example embodiments of the present disclosure;

FIG. 4 illustrates a perspective view of an example display cover for a wearable computing device according to example embodiments of the present disclosure;

FIG. 5 illustrates a bottom view of the example display cover of FIG. 4 according to example embodiments of the present disclosure;

FIG. 6 depicts a block diagram of components of an example display assembly according to example embodiments of the present disclosure;

FIG. 7 illustrates a three-dimensional view of the example display assembly of FIG. 6 according to example embodiments of the present disclosure;

FIG. 8 illustrates a cross-sectional view of the example display assembly of FIG. 6 according to example embodiments of the present disclosure;

FIG. 9 illustrates a top view of the example display of FIGS. 6-8 according to example embodiments of the present disclosure; and

FIG. 10 depicts a block diagram of components of a computing system of an example wearable computing device according to example embodiments of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made in the present disclosure without departing from the scope or spirit of the disclosure.

For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to a wearable computing device that can be worn, for instance, on a user's wrist. The wearable computing device can include a housing and a display. The display can be configured to display content for viewing by the user. The wearable computing device can further include a display cover positioned on the housing such that the display cover is positioned over the display. In this manner, the display cover can protect the display from being damaged (e.g., scratched). Furthermore, the display cover can include a transparent material (e.g., glass). In this manner, the user can view the content on the display assembly through the display cover.

Example aspects of the present disclosure are directed to a display assembly that can be used in wearable computing devices. The display assembly can include a display cover which defines an internal volume. The display assembly can further include a display (e.g., organic light emitting diode (OLED) display) positioned within the internal volume. It should be understood that the display cover can be positioned above the display disposed within the internal volume. Furthermore, the display can include a first display area (e.g., primary display area) and a second display area (e.g., secondary display area). It should be understood that the first display area and the second display area can each include a plurality of pixels. The first display area can be disposed within a central portion of the internal volume. The second display area can be disposed at least partially within a peripheral portion of the internal volume. For instance, the second display area can extend around a periphery of the first display area within the internal volume. In some implementations, the second display area can be coupled to the periphery of the first display area.

The display can further include an arcuate (e.g., curved) connection portion disposed within the peripheral portion of the internal volume. Additionally, the arcuate connection portion can be disposed on a portion of the second display area. For instance, in some implementations, the arcuate connection portion can be disposed on an outer surface of the second display area within the peripheral portion of the internal volume. Furthermore, the arcuate connection portion can define a periphery (e.g., an outer edge) of the second display area. For instance, the arcuate connection portion can have a shape similar to that of the periphery of the second display area. In some implementations, the arcuate connection portion and the periphery of the second display area can also have a shape similar to that of a periphery of the display cover.

The arcuate connection portion can be configured to bend the second display area in a curved manner within the peripheral portion of the internal volume. Additionally, the arcuate connection portion can be configured to bend the second display area around a circumference of the first display area. For instance, the second display area can include a top portion extending from the periphery of the first display area to a first end of the arcuate connection portion, a curved portion defined by the arcuate connection portion (e.g., extending between the first end and a second end of the arcuate connection portion), and a bottom portion extending from the second end of the arcuate connection portion toward the central portion of the internal volume. In this manner, the arcuate connection portion can be configured to bend (e.g., fold) the second display area such that the bottom portion of the second display area is disposed beneath at least a portion of the top portion of the second display area within the internal volume. It should be understood that the top portion of the second display area and the bottom portion of the second display area are different.

The display assembly can further include a first plurality of conductors and a second plurality of conductors. Each conductor of the first plurality of conductors can be electrically coupled to a corresponding pixel of the plurality of pixels included in the first display area. Likewise, each conductor of the second plurality of conductors can be electrically coupled to a corresponding pixel of the plurality of pixels included in the second display area. In this manner, the first display area and the second display area can be controlled independently of one another.

The display assembly can further include a display driver circuit having dedicated memory buffers for each of the display areas (e.g., first display area, second display area). For instance, the display assembly can include a first memory buffer and a second memory buffer. The first memory buffer can be communicatively coupled to each of the pixels of the first display area via a corresponding conductor of the first plurality of conductors. Likewise, the second memory buffer can be communicatively coupled to each of the pixels of the second display area via a corresponding conductor of the second plurality of conductors. In this manner, the first display area and the second display area can be independently controlled. For instance, in some implementations, the second display area can be controlled to function as an always-on display (AOD).

A wearable computing device according to example aspects of the present disclosure can provide numerous technical effects and benefits. In some implementations, the display having an arcuate connection portion configured to bend the periphery of the second display area allows the display to accommodate the shape of the peripheral portion of the internal volume. For instance, disposing the arcuate connection portion on the periphery of the second display area allows the second display area to have a shape similar to that of the periphery of the display cover. In this manner, the second display area and the arcuate connection portion can eliminate the need for having a separate element (e.g., a bezel) disposed around the periphery of the display cover because the arcuate connection portion is configured to bend the second display area around the peripheral region of the internal volume. Furthermore, by eliminating the need for a separate element (e.g., bezel) disposed around the periphery of the display cover, the size of the display itself can be maximized. Still further, because the display includes dedicated conductors and memory buffers for the first display area and the second display area respectively, the first display area and the second display area can be controlled independently of each other.

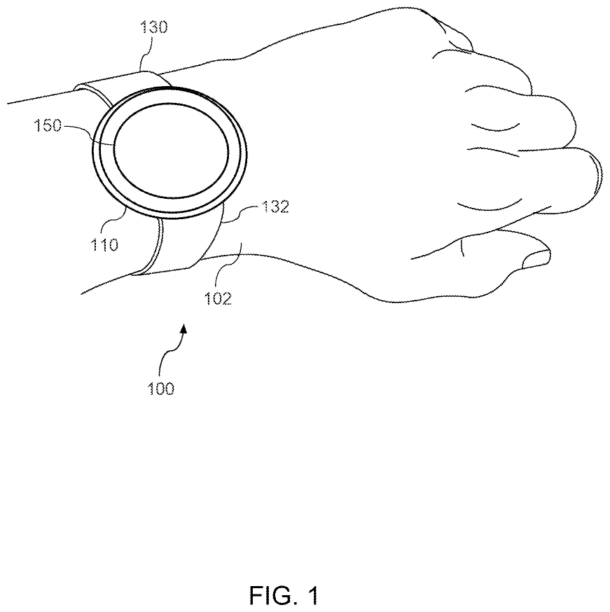

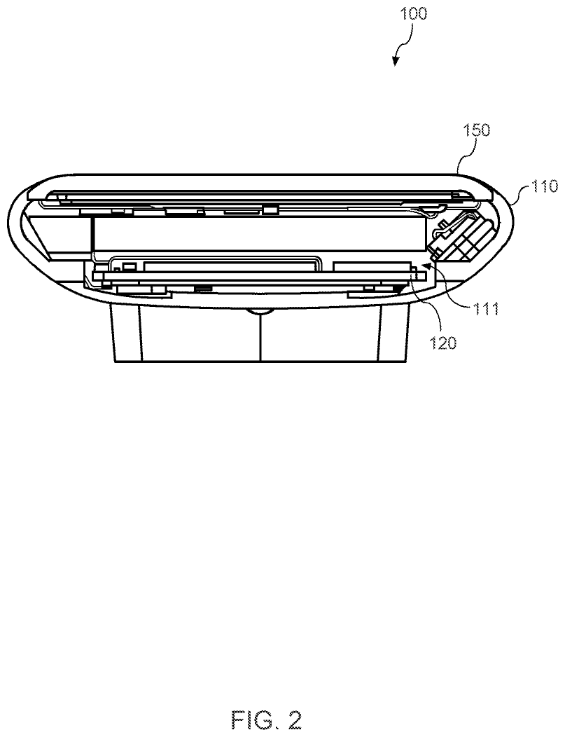

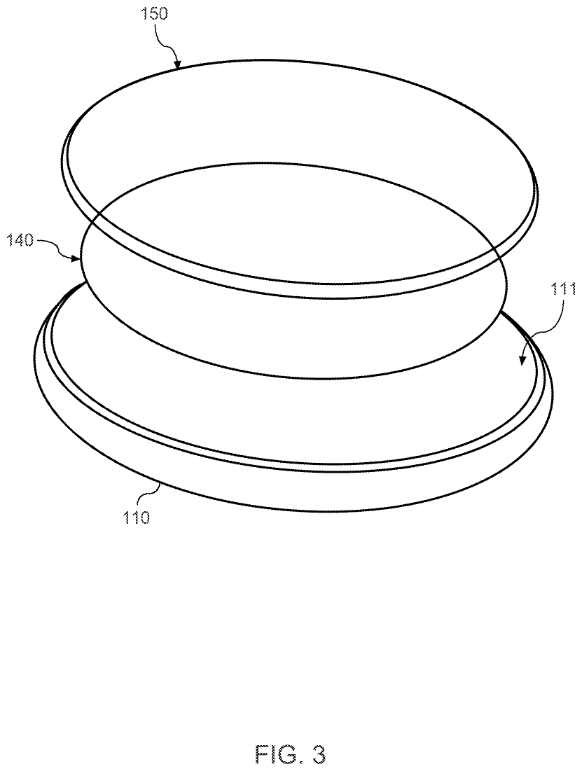

Referring now to the Figures, FIG. 1 through FIG. 3 illustrate a wearable computing device 100 according to some implementations of the present disclosure. As shown, the wearable computing device 100 can be worn, for instance, on an arm 102 (e.g., wrist) of a user. The wearable computing device 100 can include a housing 110. The housing 110 can define a cavity 111 (e.g., internal volume) in which one or more electronic components (e.g., disposed on printed circuit boards) are disposed. For instance, the wearable computing device 100 can include a printed circuit board 120 (e.g., flexible printed circuit board) disposed within the cavity 111. Furthermore, one or more electronic components can be disposed on the printed circuit board 120. The wearable computing device 100 can further include a battery (not shown) that is disposed within the cavity 111 defined by the housing.

The wearable computing device 100 can include a first band 130 and a second band 132. As shown, the first band 130 can be coupled to the housing 110 at a first location thereon. Conversely, the second band 132 can be coupled to the housing 110 at a second location thereon. Furthermore, the first band 130 and the second band 132 can be coupled to one another at a third location (not shown) to secure the housing 110 to the arm 102 of the user.

In some embodiments, the first band 130 can include a buckle or clast (not shown). Additionally, the second band 132 can include a plurality of apertures (not shown) spaced apart from one another along a length of the second band 132. In such embodiments, a prong of the buckle associated with the first band 130 can extend through one of the plurality of openings defined by the second band 132 to couple the first band 130 to the second band 132.

It should be appreciated that the first band 130 can be coupled to the second band 132 using any suitable type of fastener. For instance, in some embodiments, the first band 130 and the second band 132 can include a magnet (not shown). In such embodiments, the first band 130 and the second band 132 can be magnetically coupled to one another to secure the housing 110 to the arm 102 of the user.

The wearable computing device 100 can include a display 140 configured to display content (e.g., time, date, biometric, notifications, etc.) for viewing by the user. The display 140 can include a plurality of pixels. For instance, in some embodiments, the display 140 can include an organic light-emitting diode (OLED) display. It should be understood, however, that the display 140 can include any suitable type of display.

The wearable computing device 100 can include a display cover 150 positioned on the housing 110 such that the display cover 150 is positioned on top of the display 140. In this manner, the display cover 150 can protect the display 140 from being damaged (e.g., scratched or cracked). In some embodiments, the wearable computing device 100 can include a seal (not shown) positioned between the housing 110 and the display cover 150. For instance, a first surface of the seal can contact the housing 110 and a second surface of the seal can contact the display cover 150. In this manner, the seal between the housing 110 and the display cover 150 can prevent a liquid (e.g., water) from entering the cavity 111 defined by the housing 110.

It should be understood that the display cover 150 can be optically transparent so that the user can view information being displayed on the display 140. For instance, in some embodiments, the display cover 150 can include a glass material. It should be understood, however, that the display cover 150 can include any suitable optically transparent material.

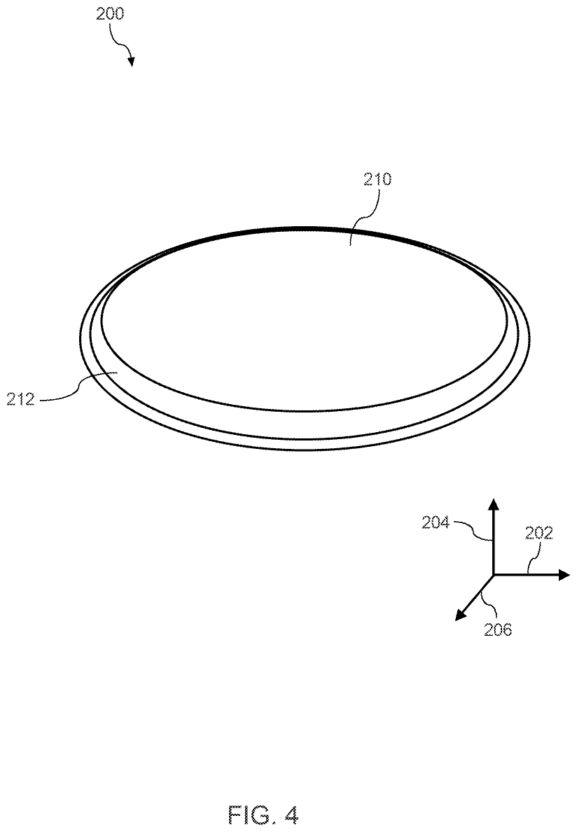

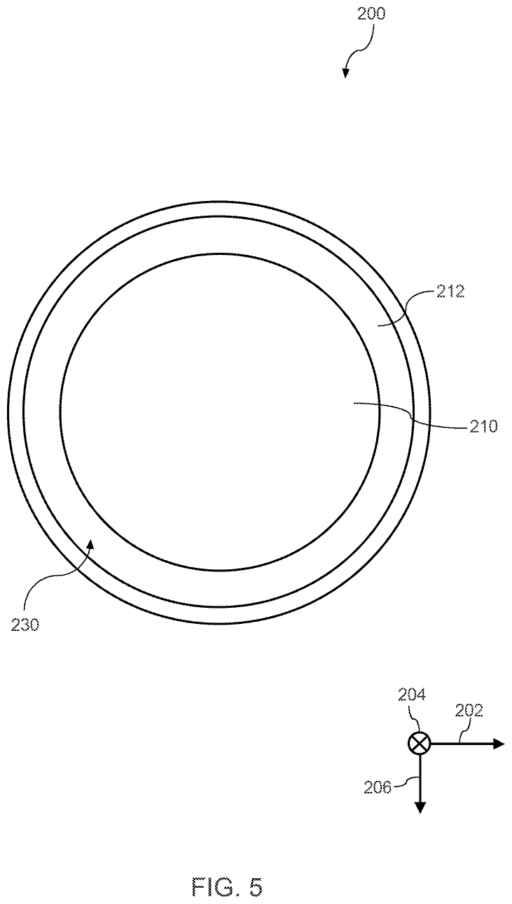

Referring now to FIG. 4 and FIG. 5, a three-dimensional display cover 200 for a wearable computing device is provided. The display cover 200 defines an x-axis 202, a y-axis 204, and a z-axis 206. It should be understood that the x-axis 2002, the y-axis 204, and the z-axis 206 are substantially perpendicular (e.g., less than a 15-degree difference, less than a 10-degree difference, less than a 5-degree difference, less than a 1-degree difference, etc.) to one another. It should also be understood that wearable computing device 100 discussed above with reference to FIG. 1 through FIG. 3 can include the display cover 200. For instance, the display cover 150 discussed above with reference to FIG. 1 through FIG. 3 can include the display cover 200. Details of the display cover 200 will now be discussed.

The display cover 200 can include a first portion 210 (hereinafter referred to as central portion 210) and a second portion 212 (hereinafter referred to as peripheral portion 212). The central portion 210 of the display cover 200 can extend along the x-axis 202 and the z-axis 206. In this manner, the central portion 210 can be substantially flat. The peripheral portion 212 of the display cover 200 can extend from the central portion 210 of the display cover 200 along the y-axis 204. The peripheral portion 212 can have an annular shape. Furthermore, the peripheral portion 212 of the display cover 200 can extend around a periphery of the central portion 210 of the display cover 200. In this manner, the central portion 210 of the display cover 200 and the peripheral portion 212 of the display cover 200 can collectively define an internal volume 230 in which a display of a wearable computing device can be positioned. In some implementations, the display cover 200 can have a frustoconical shape.

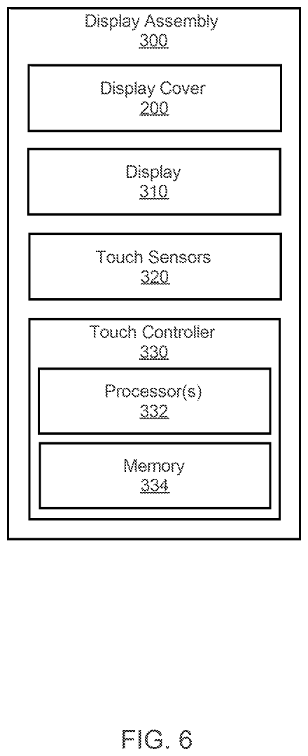

Referring now to FIG. 6, a block diagram of components of an example display assembly 300 for use with a display cover is provided according to example embodiments of the present disclosure. For instance, in some embodiments, the display assembly 300 can include the display cover 200 discussed above with reference to FIG. 4 and FIG. 5. It should be understood, however, that the display assembly 300 can include any suitable display cover for a display of an electronic device.

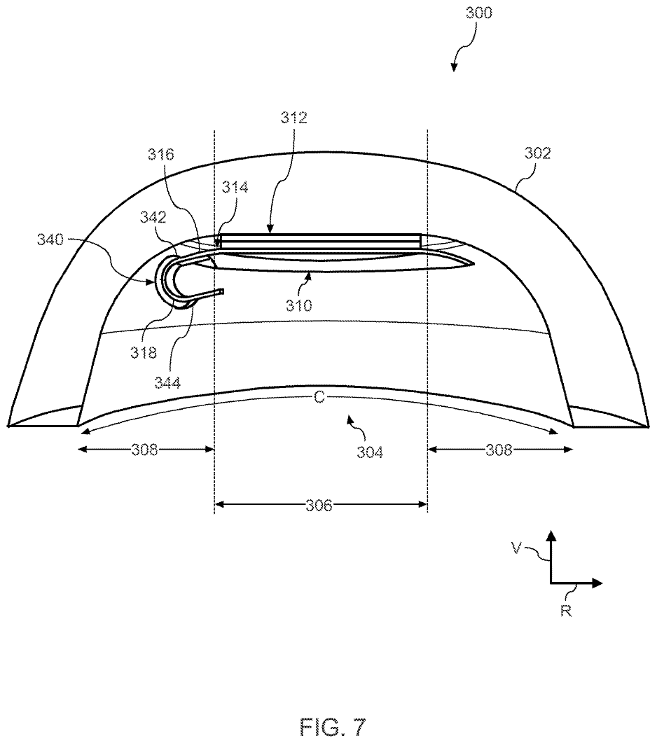

The display assembly 300 can include a display 310. The display 310 can be at least partially positioned within the internal volume 230 (FIG. 5) of the display cover 200. In this manner, the display cover 200 can protect the display 310 from being damaged (e.g., scratched, cracked). The display 310 can include a plurality of different layers. It should be understood that the plurality of different layers can be stacked on top of one another to form the display 310. It should also be understood that the layers can include different materials and/or components. For instance, a display layer of the display 310 can include a plurality of pixels that can be controlled to display content for viewing by a user. Furthermore, in some embodiments, the display 310 can include a plurality of different display areas. For instance, as will be discussed in further detail below with reference to FIG. 7 through FIG. 9, the display 310 can include a first display area and a second display area extending around a periphery of the first display area.

The display assembly 300 can include a plurality of touch sensors 320 for detecting touch input by the user touching the display cover 200 (FIG. 4 and FIG. 5). For instance, the plurality of touch sensors 320 can include a first plurality of touch sensors operable to detect a touch input provided by the user touching the central portion 210 (FIG. 4 and FIG. 5) of the display cover 200 and a second plurality of touch sensors operate to detect a touch input provided by the user touching the peripheral portion 212 (FIG. 4 and FIG. 5) of the display cover 200.

In some embodiments, one or more of the touch sensors 320 can include a capacitive sensor whose capacitance changes when touch input is provided at a location on the display cover 200 that corresponds to the capacitive sensor. It should be understood, however, that the touch sensors 320 can include any suitable type of sensor configured to detect touch input provided by the user touching the display cover 200.

The display assembly 300 can include a controller 330. The controller 330 can include one or more processors 332 and a memory 334. The processor(s) 332 can be communicatively coupled to the plurality of touch sensors 320. In this manner, the processor(s) can receive signals from the plurality of touch sensors 320. Furthermore, the memory 334 can store instructions 336 that, when executed by the processor(s) 332, cause the processor(s) 332 to process the signals received from the plurality of touch sensors 320 and perform one or more actions based on the location at which the touch input was provided. For instance, in some embodiments, the processor(s) 332 can be configured to update the content displayed by the display 310, specifically the display layer thereof.

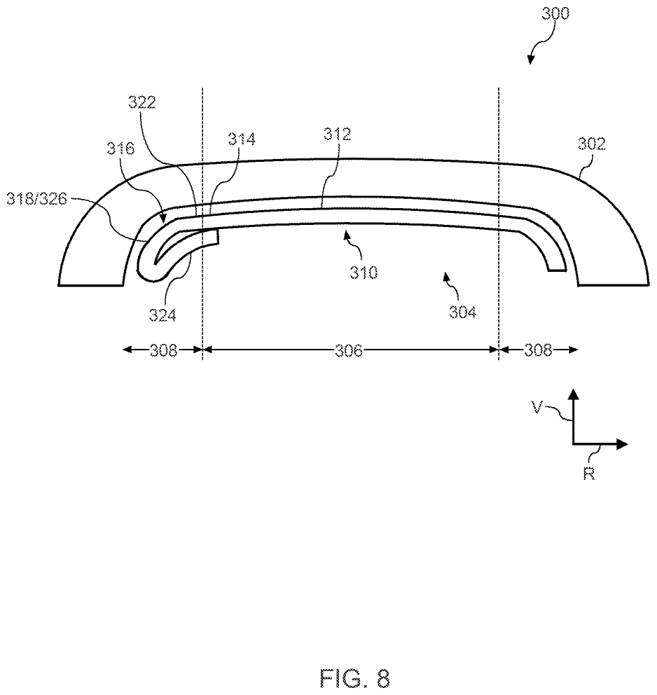

Referring now to FIG. 7 and FIG. 8, a three-dimensional view (FIG. 7) and a cross-sectional view (FIG. 8) of the example display assembly 300 of FIG. 6 are provided according to example embodiments of the present disclosure. In some implementations, the display assembly 300 can define a circumferential direction C, a radial direction R, and a vertical direction V. The display assembly 300 can be implemented in wearable computing devices such as, for instance, the wearable computing device 100 discussed above with reference to FIG. 1 through FIG. 3. It should be understood, however, that the display assembly 300 can be used in any suitable electronic device. Furthermore, the display assembly 300 can include a display cover 302. For instance, in some embodiments, the display assembly 300 can include the display cover 200 discussed above with reference to FIG. 4 and FIG. 5. It should be understood, however, that the display assembly 300 can include any suitable display cover for a display of an electronic device.

The display assembly 300 can include the display 310 discussed above with reference to FIG. 6. As shown, the display 310 can be at least partially positioned within an internal volume 304 defined by the display cover 302. For instance, in some embodiments, the display 310 can be positioned within the internal volume 230 defined by the display cover 200 discussed above with reference to FIG. 5. As shown, the internal volume 304 can include a central portion 306 and a peripheral portion 308 extending around a periphery of the central portion 306 in a circumferential direction.

As noted above, the display 310 can include a first display area 312 and a second display area 316. More specifically, in some embodiments, the first display area 312 can be disposed within the central portion 306 of the internal volume 304 and the second display area 316 can be disposed at least partially within the peripheral portion 308 of the internal volume 304. In some embodiments, the central portion 210 of the display cover 200 (FIGS. 4-5) can be positioned above the first display area 312 and the peripheral portion 212 of the display cover 200 (FIGS. 4-5) can be positioned at least partially above the second display area 316. Furthermore, the second display area 316 can be positioned within the internal volume 304 such that the second display area 316 extends along a circumferential direction C of the display cover 302. For instance, the second display area 316 can extend around a circumference of the display cover 302. Furthermore, the second display area 316 can extend around the periphery 314 of the first display area 312 in a circumferential direction, thereby enlarging a total area (i.e., combined area of the first display area 312 and the second display area 316) available for displaying content to a user. In this manner, the display 310 can be extended such that content can be viewed from other portions (e.g., peripheral portion) of the display cover 302.

In some embodiments, the first display area 312 can include a first plurality of pixels (not shown) and the second display area 316 can include a second plurality of pixels (not shown). It should be understood that the first plurality of pixels and the second plurality of pixels can be independently controlled to display content for viewing by a user. For instance, in some embodiments, the first display area 312 and the second display area 316 can be made from an organic light-emitting diode (OLED) display. It should be understood, however, that the first display area 312 and the second display area 316 can be made from any suitable type of display.

In some implementations, the second display area 316 can be configured as an always-on-display. Alternatively or additionally, the second display area 316 can be configured as a touch-screen display. For instance, the second display area 316 can include one or more touch sensors. In this manner, a user can provide user-input (e.g., touch, scroll, etc.) via the second display area 316.

The display assembly 300 can further include an arcuate connection portion 340 disposed on the second display area 316. The arcuate connection portion can be made of a transparent material. In this manner, content displayed on the second display area 316 can be seen by a user.

In some embodiments, the arcuate connection portion 340 can be disposed on the portion of the second display area 316 that is positioned within the peripheral portion 308 of the internal volume 304. For instance, in some embodiments, the arcuate connection portion 340 can extend around a periphery 318 of the second display area 316 within the internal volume 304. More specifically, the arcuate connection portion 340 can extend around the circumference of the periphery 318 of the second display area 316. In this manner, the arcuate connection portion 340 can define the periphery 318 of the second display area 316. In some embodiments, the arcuate connection portion 340 can include a substrate that includes a flexible material. In some embodiments, the flexible material can be plastic. It should be understood, however, that the substrate can include any suitable material that allows the substrate to bend to form the shape of the second display area 316.

The second display area 316 can further include a top portion 322, a bottom portion 324, and a curved portion 326. The top portion 322 of the second display area 316 can extend in a radial direction outward from the periphery 314 of the first display area 312 to a first end 342 of the arcuate connection portion 340. In some embodiments, the top portion 322 of the second display area 316 can extend in both a radial direction and a vertical direction from the periphery 314 of the first display area 312 to the first end 342 of the arcuate connection portion 340. For instance, in some embodiments, the top portion 322 of the second display area 316 can slope away from the periphery 314 of the first display area 312 towards the first end 342 of the arcuate connection portion 340. In some embodiments, the top portion 322 of the second display area 316 can be flat. The bottom portion 324 of the second display area 316 can extend in an inward radial direction and/or a vertical direction from a second end 344 of the arcuate connection portion 340 toward the central portion 306 of the internal volume 304. For instance, in some embodiments, the bottom portion 324 of the second display area 316 can be disposed at least partially underneath the top portion 322 of the second display area 316. In this manner, the second display area 316 can be configured to bend around the peripheral portion 308 of the internal volume 304 in a circumferential direction.

The curved portion 326 of the second display area 316 can extend from the first end 342 of the arcuate connection portion 340 to the second end 344 of the arcuate connection portion 340. In some embodiments, the shape and/or slope of the second display area 316 can change at the border (e.g., at the first end 342 of the arcuate connection portion 340) between the top portion 322 and the curved portion 326 of the second display area 316. For instance, as shown, the second display area 316 can be flat along the top portion 322 and can begin to take a curved shape (e.g., slope away) in a radial direction at the first end 342 of the arcuate connection portion 340. In some embodiments, the curved portion 326 of the second display area 316 can correspond to the periphery 318 of the second display area 316. For instance, in some embodiments, the arcuate connection portion 340 can be disposed on the curved portion 326 of the second display area 316. In this manner, the arcuate connection portion 340 can define the curved portion 326 of the second display area 316.

In some embodiments, the arcuate connection portion 340 can be configured to bend the second display area 316 in a circumferential direction around the peripheral portion 308 of the internal volume 304. In some embodiments, the second display area 316 can be configured to bend around the peripheral portion 308 of the internal volume 304 in a circular shape.

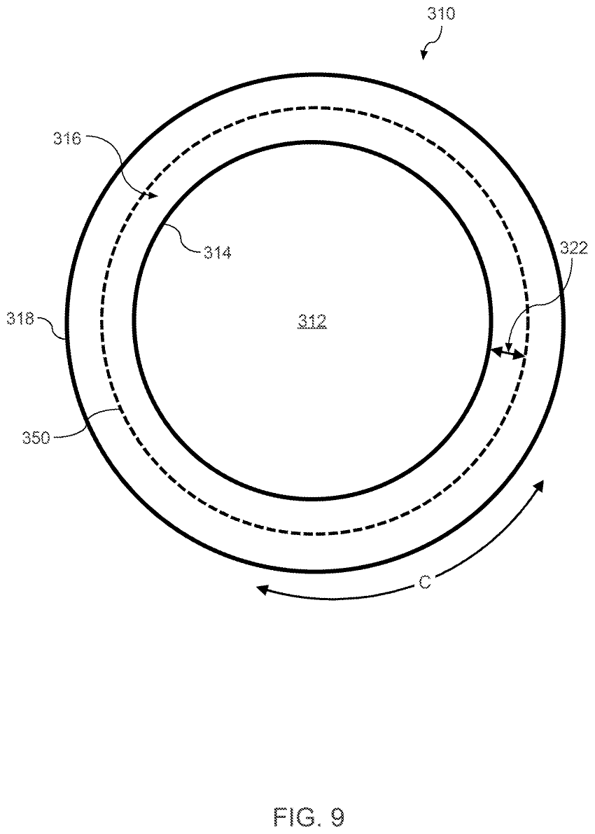

For instance, referring now to FIG. 9, a top view of an example display is provided according to example aspects of the present disclosure. It should be understood that the example display can be the display 310 discussed above with reference to FIG. 6 through FIG. 8. Furthermore, it should be understood that the display 310 can be disposed within the internal volume 304 (FIG. 8) defined by the display cover 302 (FIG. 8).

As shown in FIG. 9, the second display area 316 can extend around the periphery 314 of the first display area 312 in a circumferential direction. For instance, the second display area 316 can extend around a circumference of the first display area 312. As discussed above, in some embodiments, the arcuate connection portion 340 (not shown) can define the periphery 318 of the second display area 316. Moreover, as discussed above, the curved portion 326 of the second display area 316 can extend between the first end 342 (represented by line 350) and the second end 344 (not shown) of the arcuate connection portion 340.

Furthermore, the curved portion 326 of the second display area 316 can be configured to bend in a circular shape around the periphery 314 of the first display area 312. It should be understood that the arcuate connection portion 340 can be disposed on the curved portion 326 in such a manner as to bend the second display area 316 within the peripheral portion 308 of the internal volume 304. In this manner, the bottom portion 324 (not shown) of the second display area 316 can extend from the second end 344 of the arcuate connection portion 340 towards the central portion 306 of the internal volume 304 such that the bottom portion 324 of the second display area 316 is disposed at least partially underneath the top portion 322 of the second display area 316 (shown in FIG. 8). For instance, in some embodiments, the bottom portion 324 of the second display area 316 can be folded underneath the top portion 322 of the second display area 316. Furthermore, it should be understood that, in some embodiments, the second display area 316 can be configured to bend in a rectilinear shape.

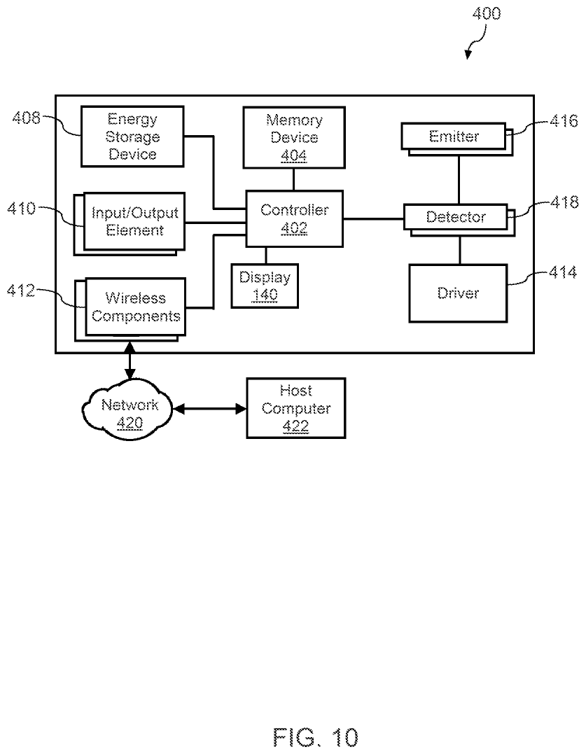

Referring now to FIG. 10, components of an example computing system 400 of the wearable computing device 100 that can be utilized in accordance with various embodiments are illustrated. In particular, as shown, the computing system 400 may include at least one controller 402. Moreover, in some embodiments, the controller(s) 402 can be a central processing unit (CPU) or graphics processing unit (GPU) for executing instructions that can be stored in a memory device 404, such as flash memory or DRAM, among other such options. For instance, in some embodiments, the memory device 404 may include RAM, ROM, FLASH memory, or other non-transitory digital data storage, and may include a control program comprising sequences of instructions which, when loaded from the memory device 404 and executing using the controller(s) 402, cause the controller(s) 402 to perform the functions that are described herein.

The computing system 400 can include many types of memory, data storage, or computer-readable media, such as data storage for program instructions for execution by the controller(s) 402 or any suitable processor. The same or separate storage can be used for images or data, a removable memory can be available for sharing information with other devices, and any number of communication approaches can be available for sharing with other devices. In addition, as shown, the computing system 400 includes the display 140, which may be a touch screen, organic light-emitting diode (OLED), or liquid crystal display (LCD), although devices might convey information via other means, such as through audio speakers, projectors, or casting the display or streaming data to another device, such as a mobile phone, wherein an application on the mobile phone displays the data.

The computing system 400 can include one or more wireless networking components 412 operable to communicate with one or more electronic devices within a communication range of a particular wireless channel. The wireless channel can be any appropriate channel used to enable devices to communicate wirelessly, such as Bluetooth, cellular (e.g., 3G, 4G, LTE, 5G), near-field communication (NFC), Ultra-Wideband (UWB), or Wi-Fi channels. It should be understood that the computing system 400 can have one or more conventional wired communications connections as known in the art.

The computing system 400 can also include one or more power components 408 (e.g., energy storage device(s)) operable to be recharged through conventional plug-in approaches. In some embodiments, the computing system 400 can also include at least one additional Input/Output (I/O) device 410 operable to receive conventional inputs from a user. These conventional inputs can include, for instance, a push button, touch pad, touch screen, wheel, joystick, keyboard, mouse, keypad, or any other suitable device or element whereby a user can input a command to the computing system 400. In some embodiments, the I/O device(s) 410 can be connected by a wireless infrared or Bluetooth or other link as well. In some embodiments, the computing system 400 can include a microphone or other audio-capture element that accepts voice or other audio commands. In some embodiments, the I/O device(s) 410 can include one or more electrodes, optical sensors, barometric sensors (e.g., altimeter, etc.), and the like.

The computing system 400 can include a driver 414 and at least some combination of one or more emitters 416 and one or more detectors 418 for measuring data for one or more metrics of a human body, such as for a person wearing the wearable computing device 100. In some embodiments, for instance, this may involve at least one imaging element (not shown), such as one or more cameras that are able to capture images of the surrounding environment and that are able to image a user, people, or objects in the vicinity of the device. The image capture element can include any appropriate technology, such as a Charge-Coupled Device (CCD) image capture element having a sufficient resolution, focal range, and viewable area to capture an image of the user when the user is operating the device. Further image capture elements may also include depth sensors.

Methods for capturing images using a camera element with a computing device are well known in the art and will not be discussed herein in detail. It should be understood that image capture can be performed using a simple image, multiple images, periodic imaging, continuous image capture, image streaming, etc. Furthermore, the computing system 400 can include the ability to start and/or stop image capture, such as when receiving a command from a user, application, or other device.

The emitters 416 and the detectors 418 may also be capable of being used, in some embodiments, for obtaining optical photoplethysmogram (PPG) measurements. Some PPG technologies rely on detecting light at a single spatial location, or adding signals taken from two or more spatial locations. Both of these approaches result in a single spatial measurement from which the heart rate (HR) estimate (or other physiological metrics) can be determined. In some embodiments, a PPG device employs a single light source coupled to a single detector (e.g., a single light path). Alternatively, a PPG device may employ multiple light sources coupled to a single detector or multiple detectors (e.g., two or more light paths). In other embodiments, a PPG device employs multiple detectors coupled to a single light source or multiple light sources (e.g., two or more light paths). In some instances, the light source(s) may be configured to emit one or more of green, red, infrared (IR) light, as well as any other suitable wavelengths in the spectrum (e.g., long IR for metabolic monitoring). For instance, a PPG device may employ a single light source and two or more light detectors, each of which configured to detect a different wavelength or wavelength range. In other embodiments, two or more detectors can be configured to detect the same wavelength or wavelength range. In yet another embodiment, one or more detectors can be configured to detect a specific wavelength or wavelength range that is different from one or more other detectors. In embodiments employing multiple paths, the PPG device may determine an average of the signals resulting from the multiple paths before determining an HR estimate or other physiological metrics.

Moreover, in some embodiments, the emitters 416 and the detectors 418 can be coupled to the controller 402 directly or indirectly using driver circuitry by which the controller 402 may drive the emitters 416 and obtain signals from the detectors 418. The host computer 422 can communicate with the wireless networking components 412 via the one or more networks 420, which may include one or more local area networks, wide area networks, UWB, and/or internetworks using any of terrestrial or satellite links. In some embodiments, the host computer 422 can execute control programs and/or application programs that are configured to perform the functions described herein.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A display assembly comprising:
a display cover defining an internal volume having a central portion and a peripheral portion; and
a display comprising:
a first display area disposed within the central portion of the internal volume and having a first plurality of pixels;
a second display area disposed at least partially within the peripheral portion of the internal volume and having a second plurality of pixels, the second display area extending around a periphery of the first display area; and
an arcuate connection portion disposed on the second display area, the arcuate connection portion defining a periphery of the second display area.

2. The display assembly of claim 1, wherein the second display area further comprises:
a top portion extending from the periphery of the first display area to a first end of the arcuate connection portion;
a curved portion defined by the arcuate connection portion, the curved portion extending between the first end of the arcuate connection portion and a second end of the arcuate connection portion; and
a bottom portion extending from the second end of the arcuate connection portion toward the central portion of the internal volume.

3. The display assembly of claim 2, wherein the top portion of the second display area is flat.

4. The display assembly of claim 1, wherein the arcuate connection portion is configured to bend the second display area within the peripheral portion of the internal volume.

5. The display assembly of claim 4, wherein the arcuate connection portion is configured to bend the second display area in a circular shape.

6. The display assembly of claim 4, wherein the arcuate connection portion comprises a substrate formed from a flexible material.

7. The display assembly of claim 6, wherein the arcuate connection portion comprises a plastic substrate.

8. The display assembly of claim 1, further comprising:
a first plurality of touch sensors, each of the first plurality of touch sensors operable to detect a touch input provided at a central portion of the display cover; and
a second plurality of touch sensors, each of the second plurality of touch sensors operable to detect a touch input provided at a peripheral portion of the display cover.

9. The display assembly of claim 1, further comprising:
a first plurality of conductors, each conductor of the first plurality of conductors electrically coupled to a corresponding pixel of the first plurality of pixels;
a second plurality of conductors, each conductor of the second plurality of conductors electrically coupled to a corresponding pixel of the second plurality of pixels; and
a display driver circuit comprising:
a first memory buffer communicatively coupled to each of the first plurality of pixels via a corresponding conductor of the first plurality of conductors; and
a second memory buffer communicatively coupled to each of the second plurality of pixels via a corresponding conductor of the second plurality of conductors.

10. The display assembly of claim 1, wherein a total number of pixels included in the first plurality of pixels is different than a total number of pixels included in the second plurality of pixels.

11. The display assembly of claim 1, wherein the display cover is formed from a transparent material.

12. The display assembly of claim 1, wherein the first display area and the second display area comprise an organic light-emitting diode (OLED) display.

13. A wearable computing device comprising:
a housing;
a display cover positioned on the housing and defining an internal volume having a central portion and a peripheral portion; and
a display positioned within the internal volume, the display comprising:
a first display area disposed within the central portion of the internal volume and having a first plurality of pixels;
a second display area disposed at least partially within the peripheral portion of the internal volume and having a second plurality of pixels, the second display area extending around a periphery of the first display area;
an arcuate connection portion disposed on the second display area, the arcuate connection portion defining a periphery of the second display area.

14. The wearable computing device of claim 13, further comprising:
a first plurality of conductors, each conductor of the first plurality of conductors electrically coupled to a corresponding pixel of the first plurality of pixels;
a second plurality of conductors, each conductor of the second plurality of conductors electrically coupled to a corresponding pixel of the second plurality of pixels; and
a display driver circuit comprising:
a first memory buffer communicatively coupled to each of the first plurality of pixels via a corresponding conductor of the first plurality of conductors; and
a second memory buffer communicatively coupled to each of the second plurality of pixels via a corresponding conductor of the second plurality of conductors.

15. The wearable computing device of claim 13, wherein the arcuate connection portion is configured to bend the second display area within the peripheral portion of the internal volume.

16. The wearable computing device of claim 15, wherein:
the housing is circular; and
the arcuate connection portion is configured to bend the second display area in a circular shape.

17. The wearable computing device of claim 13, wherein the arcuate connection portion comprises a substrate formed from a flexible material.

18. The wearable computing device of claim 17, wherein the arcuate connection portion comprises a plastic substrate.

19. The wearable computing device of claim 13, wherein the display cover is formed from a transparent material.

20. The wearable computing device of claim 13, wherein the first display area and the second display area comprise an organic light-emitting diode (OLED) display.
